(19) United States
(12) Patent Application Publication
(10) Pub. No.: US 2004/0021080 A1
(43) Pub. Date: Feb. 5, 2004

(54) Method for measuring the level of a medium in a reactor

(76) Inventors: Wofgang Bidell, Mannheim (DE); Gerard Lutz, Koln (DE); Franz Langhauser, Ruppersberg (DE); Gunther Scherer, Neustadt an der Weinstrasse (DE); Dirk Meckelnburg, Ludwigshafen (DE); Jurgen Oelze, Ludwigshafen (DE); Hans-Jurgen Gerbig, Speyer (DE); Jurgen Huhnerben, Katherinen (DE)

Correspondence Address: Keil & Weinkauf, 1101 Connecticut Avenue N W, Washington, DC, 20036, US

(21) Appl. No.: 10/362,055

(22) PCT Filed: Aug. 22, 2001
(86) PCT No.: PCT/EP01/09683

(30) Foreign Application Priority Data
Aug. 25, 2000 (DE) 100 41 813.9

(51) Int. Cl. G01F 23/288

(52) U.S. Cl. 250/357.1

(57) ABSTRACT

In a method of measuring the fill level of a reactor in continuously operated polymerization processes using measurement of the respective phase interface in the reactor by means of ionizing radiation, at least one measuring unit comprising a radiation source which emits ionizing radiation and a corresponding detector is brought to the phase interface in the reactor and flexibly installed there, with the fill level of the reactor being measured by determining the phase interface by means of the radioactive backscattering measurement.

The present invention relates to a method of measuring the fill level of a reactor in continuously operated polymerization processes, where the respective phase interface in the reactor is measured by means of ionizing radiation, wherein at least one measuring unit comprising a radiation source which emits ionizing radiation and a corresponding detector is brought to the phase interface in the reactor and flexibly installed there, with the fill level of the reactor being measured by determining the phase interface by means of the radioactive backscattering measurement.

The present invention also relates to an apparatus for measuring the fill level of a reactor in continuously operated polymerization processes.

Continuous polymerization processes are customarily carried out in a liquid phase, in a slurry, in bulk or in the gas phase. The reaction mixture present in such a process is either operated as a fluidized bed (EP-B 0089691) or is kept in motion by moveable stirrers. For such purposes, vertical, free-standing helical stirrers, for example, are well suited (EP-B 000512, EP-B 031417).

A measurement of the fill level of the reactor is of central importance to good control of a continuously operated polymerization process, since without it stable pressure and temperature conditions and thus a constant product quality is difficult to achieve.

In many polymerization reactors, the fill level of the reactor, i.e. the phase interface between the reaction medium and the medium above it, is frequently determined by means of a radioactive absorption measurement. This is carried out using both radioactive point sources or rod sources which are either located on the external wall of the reactor or are installed in a central tube in the reactor. The respective detectors are positioned at various points in the region of the reactor wall or the reactor lid. Since the distance traveled by the radiation through the reaction medium changes with the fill level of the reactor and the reaction medium absorbs radioactive rays more strongly than does the medium above it, the respective fill height of the reaction medium can be derived from the residual radiation impinging on the detector.

The radioactive absorption measurement has the disadvantage that, due to the strong absorption of the radioactive radiation in the reaction medium, it is not possible, particularly in the case of commercial gas-phase reactors, for radiation to pass through the entire reactor, so that only a subregion can be measured. This is made worse by the absorption of the radiation by the metal of the reactor wall and the central tube, through which the radiation likewise has to pass. Furthermore, the fact that the intensity of the radiation source has to be limited because of radiation protection regulations also restricts the measurement range of the radioactive absorption measurement.

The radioactive absorption measurement is a relative measurement method which is strongly dependent, inter alia, on the arrangement of radioactive radiation source and detector and on parameters of the polymerization process and of the polymer obtained. Thus, for example, the absorption in a stirred fixed bed depends on the bulk density, the type of polymer used, the amount of circulating gas, the formation of fine dust, the reactor output and the form of the fixed bed. Absorption in a gas phase depends, inter alia, on the density of the gas and on its composition, also on the pressure and the temperature of the reactor.

Inaccuracies, relative measurements and great sensitivity to malfunctions in continuously operated polymerization processes cause pressure and temperature fluctuations which then have to be remedied by manual actions in order to ensure stable process conditions and a constant product quality in the polymer obtained. Furthermore, particularly in the case of gas-phase polymerizations in a stirred fixed bed, fluctuation of the absolute amount of fixed bed in the reactor is observed and once again has to be corrected by raising or lowering the fill level. For good operation of a reactor it would be helpful to know the absolute fill level.

It is an object of the present invention to remedy the disadvantages indicated and to develop a very simple method of measuring the fill level of the reactor in continuously operated polymerization processes, which method makes possible a direct and absolute determination of the respective phase interface. Furthermore, the object of the present invention extends to the development of an apparatus suitable for such measurements of the fill level of a reactor.

We have found that this object is achieved by a novel method of measuring the fill level of a reactor in continuously operated polymerization processes, where the respective phase interface in the reactor is measured by means of ionizing radiation, wherein at least one measuring unit comprising a radiation source which emits ionizing radiation and a corresponding detector is brought to the phase interface in the reactor and flexibly installed there, with the fill level of the reactor being measured by determining the phase interface by means of the radioactive backscattering measurement.

In the method of the present invention, use is made of at least one measuring unit comprising a radiation source which emits the ionizing radiation and a corresponding detector. Radiation source and detector can, if desired, be separated from one another by means of one or more shields, for example lead bodies. Suitable radiation sources are, inter alia, radioactive emitters such as cesium¹³⁷ or cobalt⁶⁰ sources or else a customary neutron source. Detectors which can be used are, inter alia, Geiger-Muller counters, scintillation counters or detectors in general which can detect emitted radiation.

According to the method of the present invention, such a measuring unit is brought to the phase interface in the reactor and is flexibly installed there. This can be achieved, inter alia, by the measuring unit comprising the radiation source and the detector being brought to the phase interface in the reactor and being flexibly installed there prior to commencement of the polymerization. The use of a moveable rod can, for example, be useful for this purpose. However, this can also be achieved by positioning a plurality of measuring units each comprising a radiation source and a detector at different points in the reactor but in the vicinity of the phase interface for measuring of the fill level of the reactor, with the measurement being carried out using the measuring unit closest to the phase interface. Depending on the particular product and process parameters, different measuring units may then be used if desired. The measuring units comprising radiation source and detector used for this purpose are commercially available.

In the determination of the fill level of the reactor, the phase interface is determined by means of the radioactive backscattering measurement. In this determination, use is made of the fact that a reaction medium having a relatively low density, for example a gas, always displays lower radioactive backscattering than does a reaction medium having a higher density, for example an agitated fixed bed.

The method,of the present invention is useful for measuring the fill level of a reactor in continuously operated polymerization processes, particularly processes in the liquid phase, in a slurry, in bulk or in gas phase. It can be used, inter alia, in the preparation of the various polymers made up of monomers having terminal vinyl groups. The method is particularly useful in the preparation of polymers of C₂-C₈-alk-1-enes and of vinylaromatic monomers, for example of styrene or α-methylstyrene.

Suitable C₂-C₈-alk-1-enes are, in particular, ethylene, propylene, 1-butene, 1-pentene, 1-hexene, 1-heptene and 1-octene, with preference being given to using ethylene, propylene or 1-butene. The method can be used in the preparation of homopolymers of C₂-C₈-alk-l-enes or copolymers of C₂-C₈-alk-1-enes, preferably with up to 30% by weight of copolymerized other 1-alkenes having up to 8 carbon atoms. For the purposes of the present invention, the term copolymers refers both to random copolymers and to block or impact-modified copolymers.

In general, the method of the present invention is employed in at least one reaction zone, frequently in two or more reaction zones, where the polymerization conditions differ between the reaction zones to such an extent that polymers having different properties are produced. In the case of homopolymers or random copolymers, this can be, for example, the molar mass, i.e. polymers having different molar masses are produced in the reaction zones to broaden the molar mass distribution. Preference is given to polymerizing different monomers or monomer compositions in the reaction zones. This then usually leads to block or impact-modified copolymers.

The method of the present invention is particularly well suited to measuring the fill level of a reactor in the preparation of homopolymers of propylene or copolymers of propylene with up to 30% by weight of copolymerized other 1-alkenes having up to 8 carbon atoms. These copolymers of propylene are random copolymers of block or impact-modified copolymers. If the copolymers of propylene have a random structure, they generally contain up to 15% by weight, preferably up to 6% by weight, of other 1-alkenes having up to 8 carbon atoms, in particular ethylene, 1-butene or a mixture of ethylene and 1-butene.

The block or impact-modified copolymers of propylene are polymers in which a propylene homopolymer or a random copolymer of propylene with up to 15% by weight, preferably up to 6% by weight, of other 1-alkenes having up to 8 carbon atoms is prepared in the first stage and a propylene-ethylene copolymer having an ethylene content of from 15 to 80% by weight, where the propylene-ethylene copolymer may further comprise other C₄-C₈-alk-1-enes, is then polymerized onto it in the second stage. In general, the amount of propylene-ethylene copolymer polymerized onto the polymer from the first stage is such that the copolymer produced in the second stage makes up from 3 to 60% by weight of the final product.

The method of the present invention can be used, inter alia, for measuring the fill level of a reactor in polymerizations in the gas phase, either in a fluidized bed or in a stirred gas phase.

If the method of measuring the fill level of the reactor is used in the preparation of polymers of C₂-C₈-alk-1-enes, the polymerization is preferably carried out by means of a Ziegler-Natta catalyst system. Here, use is made, in particular, of catalyst systems which comprise a titanium-containing solid component a) together with cocatalysts in the form of organic aluminum compounds b) and electron donor compounds c).

However, the method of the present invention can also be used for measuring the fill level of a reactor in polymerizations by means of Ziegler-Natta catalyst systems based on metallocene compounds or based on polymerization-active metal complexes.

To prepare the titanium-containing solid component a), the halides or alkoxides of trivalent or tetravalent titanium are generally used as titanium compounds. Titanium alkoxide halide compounds or mixtures of various titanium compounds are also possible. Preference is given to using the titanium compounds containing chlorine as halogen. Preference is likewise given to the titanium halides containing only halogen in addition to titanium, especially the titanium chlorides and in particular titanium tetrachloride.

The titanium-containing solid component a) preferably comprises at least one halogen-containing magnesium compound. For the present purposes, halogens are chlorine, bromine, iodine or fluorine, preferably bromine and in particular chlorine. The halogen-containing magnesium compounds are either used directly in the preparation of the titanium-containing solid component a) or are formed in its preparation. Magnesium compounds suitable for preparing the titanium-containing solid component a) are, in particular, magnesium halides, especially magnesium dichloride or magnesium dibromide, or magnesium compounds from which the halides can be obtained in a customary manner, for example by reaction with halogenating agents. Examples of the latter type of magnesium compounds are magnesium alkyl, magnesium aryl, magnesium alkoxy compounds and magnesium aryloxy compounds and Grignard compounds. Preferred examples of halogen-free compounds of magnesium which are suitable for preparing the titanium-containing solid component a) are n-butylethylmagnesium and n-butyloctylmagnesium. Preferred halogenating agents are chlorine and hydrogen chloride. However, the titanium halides can also serve as halogenating agent.

The titanium-containing solid component a) advantageously further comprises electron donor compounds, for example monofunctional or polyfunctional carboxylic acids, carboxylic anhydrides or carboxylic esters, also ketones, ethers, alcohols, lactones or organophosphorus or organosilicon compounds.

As electron donor compounds within the titanium-containing solid component, preference is given to using carboxylic acid derivatives and in particular phthalic acid derivatives of the formula (II)

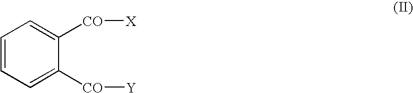

where X and Y are each a chlorine or bromine atom or a C₁-C₁₀-alkoxy radical or together represent oxygen in an anhydride function. Particularly preferred electron donor compounds are phthalic esters in which X and Y are each a C₁-C₈-alkoxy radical. Examples of preferred phthalic esters are diethyl phthalate, di-n-butyl phthalate, diisobutyl phthalate, di-n-pentyl phthalate, di-n-hexyl phthalate, di-n-heptyl phthalate, di-n-octyl phthalate and di-2-ethylhexyl phthalate.

Further preferred electron donor compounds within the titanium-containing solid component are diesters of 3- or 4-membered, substituted or unsubstituted cycloalkyl-1,2-dicarboxylic acids, and also monoesters of substituted benzophenone-2-carboxylic acids or substituted benzophenone-2-carboxylic acids. Hydroxy compounds used in these esters are the alkanols customary in esterification reactions, for example C₁-C₁₅-alkanols or C₅-C₇-Cycloalkanols which may in turn bear one or more C₁-C₁₀-alkyl groups, also C₆-C₁₀-phenols.

It is also possible to use mixtures of various electron donor compounds.

The titanium-containing solid component a) is generally prepared using from 0.05 to 2.0 mol, preferably from 0.2 to 1.0 mol, of the electron donor compounds per mol of magnesium compound.

In addition, the titanium-containing solid component a) may further comprise inorganic oxides as supports. The support used is generally a finely divided inorganic oxide which has a mean particle diameter of from 5 to 200 μm, preferably from 20 to 70 μm. For the present purposes, the mean particle diameter is the volume-based mean (median) of the particle size distribution determined by Coulter Counter analysis.

The particles of the finely divided inorganic oxide are preferably composed of primary particles having a mean diameter of from 1 to 20 μm, in particular from 1 to 5 μm. The primary particles are porous, granular oxide particles which are generally obtained from a hydrogel of the inorganic oxide by milling. It is also possible to sieve the primary particles before they are processed further.

The inorganic oxide used preferably also has voids or channels having a mean diameter of from 0.1 to 20 μm, in particular from 1 to 15 μm, and having a macroscopic proportion by volume of the total particle in the range from 5 to 30%, in particular from 10 to 30%.

The mean particle diameter of the primary particles and the macroscopic proportion by volume of the voids and channels in the inorganic oxide are preferably determined by image analysis with the aid of scanning electron microscopy or electron probe microanalysis, in each case on particle surfaces and on particle cross sections of the inorganic oxide. The micrographs obtained are evaluated and the mean particle diameter of the primary particles and the macroscopic proportion by volume of the voids and channels are determined therefrom. Image analysis is preferably carried out by converting the electron microscopic data into a halftone binary image and evaluating this digitally by means of a suitable EDP program, e.g. the software package Analysis from SIS.

The inorganic oxide preferably used can be obtained, for example, by spray drying the milled hydrogel, which for this purpose is mixed with water or an aliphatic alcohol. Such finely divided inorganic oxides are also commercially available.

Furthermore, the finely divided inorganic oxide usually has a pore volume of from 0.1 to 10 cm³/g, preferably from 1.0 to 4.0 cm³/g, and a specific surface area of from 10 to 1000 m²/g, preferably from 100 to 500 m²/g. These values are the values determined by mercury porosimetry in accordance with DIN 66133 and by nitrogen adsorption in accordance with DIN 66131.

It is also possible to use an inorganic oxide whose pH, i.e. the negative logarithm to the base 10 of the proton concentration, is in the range from 1 to 6.5, in particular from 2 to 6.

Suitable inorganic oxides are, in particular, the oxides of silicon, of aluminum, of titanium or of the metals of main groups I and II of the Periodic Table. Particularly preferred oxides are aluminum oxide, magnesium oxide, sheet silicates and especially silicon oxide (silica gel). It is also possible to use mixed oxides such as aluminum silicates or magnesium silicates.

The inorganic oxides used as supports have water present on their surface. Part of this water is physically bound by adsorption and part is chemically bound in the form of hydroxyl groups. The water content of the inorganic oxide can be reduced or completely eliminated by thermal or chemical treatment, with customary desiccants such as SiCl₄, chlorosilanes or aluminum alkyls generally being used for chemical treatment. The water content of suitable inorganic oxides is from 0 to 6% by weight. An inorganic oxide is preferably used in the form in which it is commercially available, without further treatment.

The magnesium compound and the inorganic oxide are preferably present in the titanium-containing solid component a) in such amounts that from 0.1 to 1.0 mol, in particular from 0.2 to 0.5 mol, of the magnesium compound is present per mol of the inorganic oxide.

Furthermore, the titanium-containing solid component a) is generally prepared using C₁-C₈-alkanols such as methanol, ethanol, n-propanol, isopropanol, n-butanol, sec-butanol, tert-butanol, isobutanol, n-hexanol, n-heptanol, n-octanol or 2-ethylhexanol or mixtures thereof. Preference is given to using ethanol.

The titanium-containing solid component can be prepared by methods known per se. Examples are described, for example, in EP-A 45 975, EP-A 45 977, EP-A 86 473, EP-A 171 200, GB-A 2 111 066, U.S. Pat. No. 4,857,613 and U.S. Pat. No. 5,288,824. The method known from DE-A 195 29 240 is preferably employed.

Suitable aluminum compounds b) include trialkylaluminums and also compounds in which an alkyl group is replaced by an alkoxy group or by a halogen atom, for example by chlorine or bromine. The alkyl groups may be identical or different from one another. Linear or branched alkyl groups are possible. Preference is given to using trialkylaluminum compounds whose alkyl groups each have from 1 to 8 carbon atoms, for example trimethylaluminum, triethylaluminum, triisobutylaluminum, trioctylaluminum or methyldiethylaluminum or mixtures thereof.

Apart from the aluminum compound b), use is generally made of electron donor compounds c) as further cocatalyst. Examples of such electron donor compounds c) are monofunctional or polyfunctional carboxylic acids, carboxylic anhydrides or carboxylic esters, also ketones, ethers, alcohols, lactones and organophosphorus and organosilicon compounds. These electron donor compounds c) may be identical to or different from the electron donor compounds used for preparing the titanium-containing solid component a). Preferred electron donor compounds are organosilicon compounds of the formula (I)

R¹ₙSi(OR²)₄₋ₙ (I)

where R¹ are identical or different and are each a C₁-C₂₀-alkyl group, a 5- to 7-membered cycloalkyl group which may in turn bear C₁-C₁₀-alkyl groups as substituents, a C₆-C₁₈-aryl group or a C₆-C₁₈-aryl-C₁-C₁₀-alkyl group, R² are identical or different and are each a C₁-C₂₀-alkyl group and n is 1, 2 or 3. Particular preference is given to compounds in which R¹ is a C₁-C₈-alkyl group or a 5- to 7-membered cycloalkyl group and R² is a C₁-C₄-alkyl group and n is 1 or 2.

Among these compounds, particular mention should be made of dimethoxydiisopropylsilane, dimethoxyisobutylisopropylsilane, dimethoxydiisobutylsilane, dimethoxydicyclopentylsilane, dimethoxyisopropyl-tert-butylsilane, dimethoxyisobutyl-sec-butylsilane and dimethoxyisopropyl-sec-butylsilane.

The cocatalysts b) and c) are preferably used in such amounts that the atomic ratio of aluminum from the aluminum compound b) 40 to titanium from the titanium-containing solid component a) is from 10:1 to 800:1, in particular from 20:1 to 200:1, and the molar ratio of the aluminum compound b) to the electron donor compound c) is from 1:1 to 250:1, in particular from 10:1 to 80:1.

The titanium-containing solid component a), the aluminum compound b) and the electron donor compound c) generally employed together form the Ziegler-Natta catalyst system. The catalyst constituents b) and c) can be introduced into the polymerization reactor either together with the titanium-containing solid component a) or as a mixture or individually in any order.

The novel method of measuring the fill level of a reactor can also be used in the polymerization of C₂-C₈-alk-1-enes by means of Ziegler-Natta catalyst systems based on metallocene compounds or based on polymerization-active metal complexes.

For the present purposes, metallocenes are complexes of transition metals with organic ligands, which together with compounds capable of forming metallocenium ions give effective catalyst systems. The metallocene complexes are generally present in supported form in the catalyst system. Inorganic oxides are frequently used as supports. Preference is given to the above-described inorganic oxides which are also used for the preparation of the titanium-containing solid component a).

Customarily used metallocenes contain titanium, zirconium or hafnium as central atoms, preference being given to zirconium. In general, the central atom is bound via a Π bond to at least one, generally substituted, cyclopentadienyl group and to further substituents. The further substituents can be halogens, hydrogen or organic radicals, with preference being given to fluorine, chlorine, bromine or iodine or C₁-C₁₀-alkyl groups.

Preferred metallocenes contain central atoms which are bound via two Π bonds to two substituted cyclopentadienyl groups, and particular preference is given to those in which substituents on the cyclopentadienyl groups are bound to both cyclopentadienyl groups. Very particular preference is given to complexes whose cyclopentadienyl groups are additionally substituted by cyclic groups on two adjacent carbon atoms.

Preferred metallocenes also include those which have only one cyclopentadienyl group which is, however, substituted by a radical which is also bound to the central atom.

Examples of suitable metallocene compounds are ethylenebis(indenyl)zirconium dichloride, ethylenebis(tetrahydroindenyl)zirconium dichloride, diphenylmethylene-9-fluorenylcyclopentadienylzirconium dichloride, dimethylsilanediylbis(3-tert-butyl-5-methylcyclopentadienyl)-zirconium dichloride, dimethylsilanediylbis(2-methylindenyl)zirconium dichloride, dimethylsilanediylbis(2-methylbenzindenyl)zirconium dichloride, dimethylsilanediylbis(2-methyl-4-phenylindenyl)zirconium dichloride, dimethylsilanediylbis(2-methyl-4-naphthylindenyl)zirconium dichloride, dimethylsilanediylbis(2-methyl-4-isopropylindenyl)zirconium dichloride or dimethylsilanediylbis( 2-methyl-4 , 6-diisopropylindenyl) zirconium dichloride and also the corresponding dimethylzirconium compounds.

The metallocene compounds are either known or obtainable by methods known per se.

The metallocene catalyst systems further comprise compounds capable of forming metallocenium ions. Suitable compounds capable of forming metallocenium ions are strong, uncharged Lewis acids, ionic compounds having Lewis-acid cations or ionic compounds having Brönsted acids as cations. Examples are tris(pentafluorophenyl)borane, tetrakis(pentafluorophenyl)borate or salts of N,N-dimethylanilinium. Open-chain or cyclic aluminoxane compounds are likewise suitable as compounds capable of forming metallocenium ions. These are usually prepared by reacting trialkylaluminum with water and are generally in the form of mixtures of both linear and cyclic chain molecules of various lengths.

In addition, the metallocene catalyst systems may further comprise organometallic compounds of metals of main groups I, II and III of the Periodic Table, for example n-butyllithium, n-butyl-n-octylmagnesium or triisobutylaluminum, triethylaluminum or trimethylaluminum.

The method of the present invention can be employed for measuring the fill level of a reactor in continuously operated polymerization processes in reactors customary for this purpose.

Suitable reactors are, for example, continuously operated stirred vessels, loop reactors or fluidized-bed reactors. The size of the reactors is not of critical importance for the method of the present invention. It is determined by the output which is to be achieved in the reaction zone or in the individual reaction zones.

Reactors used are, in particular, fluidized-bed reactors and also horizontally or vertically stirred powder bed reactors. The reaction bed generally comprises the polymer of C₂-C₈-alk-1-enes which is produced in the respective reactor.

The novel method of measuring the fill level of a reactor in polymerization processes can be employed in a reactor or in a cascade of reactors connected in series in which the pulverulent reaction bed is kept in motion by means of a vertical stirrer. Free-standing helical stirrers are particularly suitable for this purpose. Such stirrers are known, for example, from EP-B 000 512 and EP-B 031 417. They provide very homogeneous distribution of the pulverulent reaction bed. Examples of such pulverulent reaction beds are described in EP-B 038 478. The reactor cascade preferably comprises two tank-shaped reactors connected in series which are each provided with a stirrer and have a capacity of from 0.1 to 100 m³, for example 12.5, 25, 50 or 75 m³.

Continuous polymerization reactions in which the novel method of measuring the fill level of a reactor is used are normally carried out under customary reaction conditions at from 40 to 150° C. and pressures of from 1 to 100 bar. Preference is given to temperatures of from 40 to 100° C., in particular from 60 to 90° C., and pressures of from 10 to 50 bar, in particular from 20 to 40 bar. The molar mass of the polymers formed can be controlled and adjusted by addition of regulators customary in polymerization technology, for example hydrogen. Apart from these regulators, it is also possible to use catalyst activity regulators, i.e. compounds which influence the catalyst activity, and also antistatics. The latter prevent formation of deposits on the reactor wall as a result of electrostatic charging. The polymers obtained generally have a melt flow rate (MFR) of from 0.1 to 3000 g/10 min., in particular from 0.2 to 100 g/10 min, at 230° C. under a weight of 2.16 kg. The melt flow rate corresponds to the amount of polymer which is pressed out of the test apparatus standardized in accordance with ISO 1133 over a period of 10 minutes at 230° C. under a weight of 2.16 kg. Particular preference is given to polymers whose melt flow rate is from 0.2 to 50 g/10 min, at 230° C. under a weight of 2.16 kg.

The mean residence times in continuously operated polymerization reactions are in the range from 0.1 to 10 hours, preferably from 0.2 to 5 hours and in particular from 0.3 to 4 hours.

When the novel method of measuring the fill level of a reactor is employed in continuously operated polymerization reactors, preference is given to bringing the measuring unit or units, i.e. radiation sources and corresponding detectors, to the vicinity of the empirically determined phase interface between the individual phases in the reactor shortly before commencement of the actual polymerization, installing it appropriately flexibly there and then determining the phase interface by means of the radioactive backscattering measurement.

The radioactive residue [sic] measurement is based on the principle that ionizing radiation is backscattered to different degrees depending on the density of the fill medium and the backscattered radiation is measured by means of a detector and the height of the phase interface is thus determined. The measurement is carried out using a measuring unit comprising a radiation source and a detector, separated by a shield. A measuring unit comprising a radioactive source (Cs¹³⁷) and a scintillation detector separated by a lead shield is preferably brought to the interface between powder bed and gas space (gas-phase polymerization) by means of an impulse rate comparison.

The use of the radioactive backscattering measurement allows the influencing parameters and dependencies on half-value lengths and measuring arrangement observed in the radioactive absorption measurement to be directly circumvented. The dependencies on product and process parameters can be specifically eliminated by the flexible height adjustment of the radioactive backscattering measurement probe/detector unit.

The novel method of measuring the fill level of a reactor has, inter alia, a high sensitivity at relatively low radiation intensities of the radiation source and a significantly improved process stability, particularly when using scintillation counters. This is attributable, in particular, to the measurement accuracy being improved by the measurement signal having a discrete sawtooth structure and the radioactive backscattering measurement reacting quickly and very sensitively to changes in the fill level. For this reason, the amount discharged from the reactor per discharge can be reduced by up to 50% without this resulting in a loss of measurement accuracy, which makes possible a further improvement in the process stability in continuous polymerization reactions. Furthermore, lower pressure fluctuations in the discharge cyclone in respect of the amounts of driving gas, improved pressure and temperature fluctuations in the reactor, increased product homogeneity and a reduced tendency to form lumps in the reactor are observed.

The apparatus for measuring the fill level of a reactor in continuously operated polymerization processes, which is likewise subject matter of the present invention, is easy to handle in industry and requires little equipment. It is particularly useful in the continuous polymerization of C₂-C₈-alk-1-enes and of vinylaromatic monomers.

### EXAMPLES

The method of the present invention for measuring the fill level of a reactor was employed in the continuous preparation of a propylene homopolymer (Example 1) and of a propylene-ethylene copolymer (Example 2).

In all experiments, use was made of a Ziegler-Natta catalyst system which comprised a titanium-containing solid component a) prepared by the following method.

In a first step, a finely divided silica gel having a mean particle diameter of 30 μm, a pore volume of 1.5 cm³/g and a specific surface area of 260 m²/g was admixed with a solution of n-butyloctylmagnesium in n-heptane, using 0.3 mol of the magnesium compound per mol of SiO₂ The finely divided silica gel additionally had a mean particle size of the primary particles of 3-5 μm and had voids and channels having a diameter of 3-5 μm in a macroscopic proportion by volume of about 15% of the total particles. The mixture was stirred for 45 minutes at 95° C., then cooled to 20° C., after which 10 times the molar amount, based on the organomagnesium compound, of hydrogen chloride was passed in. After 60 minutes, the reaction product was admixed with 3 mol of ethanol per mol of magnesium while stirring continually. This mixture was stirred at 80° C. for 0.5 hour and subsequently admixed with 7.2 mol of titanium tetrachloride and 0.5 mol of di-n-butyl phthalate, in each case based on 1 mol of magnesium. The mixture was subsequently stirred at 100° C. for 1 hour, the solid obtained in this way was filtered off and washed a number of times with ethylbenzene.

The solid product obtained in this way was extracted with a 10% strength by volume solution of titanium tetrachloride in ethylbenzene for 3 hours at 125° C. The solid product was then separated from the extractant by filtration and washed with n-heptane until the washings contained only 0.3% by weight of titanium tetrachloride.

### Example 1

The polymerization was carried out in a vertically mixed gas-phase reactor having a utilizable volume of 800 1 and provided with a free-standing helical stirrer (80 revolutions/min). The reactor contained an agitated fixed bed of finely divided polymer. The reactor pressure was 32 bar. The catalyst used was the titanium-containing solid component a) which was metered in together with the fresh propylene used for regulating the pressure. The catalyst was metered in in such an amount that the mean output of 150 kg of polypropylene per hour was maintained. 450 mmol/h of triethylaluminum (in the form of a 1 molar heptane solution) and 45 mmol/h of isobutylisopropyldimethoxysilane (in the form of a 0.25 molar heptane solution) were likewise metered into the reactor. To regulate the molar mass, hydrogen was introduced. The hydrogen concentration in the reaction gas was 2.9% by volume and was determined by gas chromatography.

The heat of reaction evolved in the polymerization was removed by evaporative cooling. For this purpose, a gas stream amounting to from 4 to 6 times the quantity of gas reacted was circulated. The vaporized propylene was, after passing through the reaction zone, taken off at the top of the reactor, separated from entrained polymer particles in a circulation gas filter and condensed in a heat exchanger cooled by means of secondary water. The condensed circulating gas was pumped back into the reactor at up to 40° C. The hydrogen which is not condensable in the condenser was drawn off by means of an ejector and returned to the liquid circulating gas stream. The temperature in the reactor was regulated via the circulating gas flow and was 80° C.

Polymer powder was removed intermittently from the reactor via a tube reaching down into it by brief depressurization of the reactor. The discharge frequency was determined with the aid of the method of the present invention using radioactive backscattering measurement. This was carried out with the aid of a rod probe which was introduced into the reactor in the virtual axis of the free-standing helical stirrer and comprised a measuring unit comprising an integrated radioactive source (Cs¹³⁷, 185 MBq) and a scintillation counter.

The discharge frequency was determined via a rod probe having an integrated radioactive source (Cs¹³⁷, 185 MBq)/scintillation counter unit). Before operation, the rod probe was brought with the aid of comparison of the backscattered radiation intensity (impulse rate comparison) to the agitated phase interface between gas space and powder bed in the middle of the vortex at 80° C., 80 rpm stirrer speed and 200 kg/h of fresh propylene via the shaft gap at operating pressure prior to the commencement of the polymerization, installed there and used for monitoring the fill level of the rector. The amount of polymer powder in the reactor before commencement of the polymerization was 240 kg. After stable gas-phase polymerization for 75 hours, the reactor was vented. The amount of polymer powder in the reactor was subsequently weighed, giving a result of 236 kg.

The evaluation of the trend lines of pressure and temperature and the reproduction of the measurement signals of the radioactive backscattering measurement indicated that the temperature and pressure lines are exactly straight and allow stable gas circulation. The radioactive backscattering measurement for monitoring the fill level of the reactor gives measurement signals having a discrete sawtooth structure which allows level-controlled process conditions within narrow limits, as a result of which pressure and temperature fluctuations due to discharge are significantly improved. The individual process parameters and the properties of the propylene homopolymer obtained are reproduced in Table I below.

### Comparative Example A

The polymerization in a continuous 800 1 gas-phase reactor was carried out in a manner analogous to Example 1. The monitoring of the fill level of the reactor was carried out by means of a radioactive absorption measurement. The radioactive emitter was a Co60 rod source on the exterior wall of the reactor and the detector was located on the reactor lid. The detection of the radioactive absorption measurement under operating pressure using propylene at 80° C. in the product-free state was set at 5% and after filling with 250 kg of polymer powder was set at 95%. The polymer discharges during continuous polymerization operation occurred automatically when a measured value of 85% was reached.

After stable gas-phase polymerization for 75 hours, the reactor was vented. The amount of polymer powder in the reactor was subsequently weighed, giving a result of 227 kg.

Evaluation of the trend lines of pressure and temperature and the reproduction of the measurement signals of the radioactive absorption measurement indicated that protracted deviations of about 1-2% from the mean occurred within one hour in the trend lines of pressure and temperature. The reproduction of the measurement signals of the radioactive absorption measurement displayed irregular oscillating fluctuations in the second range, whose maxima and minima deviated by more than 50% from the mean of an idealized sawtooth curve both in respect of the intensity and in respect of the time axis. The individual process parameters and the properties of the propylene homopolymer obtained are reproduced in Table I below.

### Example 2

The polymerization in the continuous 800 1 gas-phase reactor was carried out in a manner analogous to Example 1. The rector pressure was 23 bar and the rector temperature was 80° C. The hydrogen concentration in the reaction gas was 0.2% and was determined by gas chromatography. In addition, 1.0% by volume of ethylene was metered into the reactor and the ethylene concentration was likewise determined by gas chromatography.

Before commencement of operation, the rod probe with integrated backscattering measurement was brought in a manner analogous to Example 1 to the agitated inhomogeneous phase interface between gas space and powder bed. Compared to Example 1, the rod probe had to be moved 7 cm lower for this purpose.

After stable gas-phase polymerization for 75 hours, the reactor was vented. Inspection of the interior indicated 0.6 kg of lumps in the reactor. No formation of deposits on the reactor wall or on the helical stirrer was observed. The amount of polymer powder bed in the reactor was subsequently weighed, giving a result of 237 kg.

Evaluation of the trend lines of pressure and temperature and the reproduction of the measurement signals of the radioactive backscattering measurement indicated that the temperature and pressure lines are exactly straight and allow stable gas circulation. The radioactive backscattering measurement for monitoring the fill level of the reactor gives measurement signals having a discrete sawtooth structure which allows level-controlled process conditions within narrow limits, as a result of which pressure and temperature fluctuations due to discharge are significantly improved.

The individual process parameters and the properties of the propylene-ethylene copolymer obtained are reproduced in Table I below.

### Comparative Example B

The polymerization in the continuous 800 1 gas-phase reactor was carried out in a manner analogous to Comparative Example A. The process parameters were analogous to those of Example 2.

The radioactive absorption measurement was calibrated in a manner analogous to Comparative Example A. The measured value for the level of the reactor in continuous polymerization operation was set at 89%.

After stable gas-phase polymerization for 75 hours, the reactor was vented. Inspection of the interior revealed 4 kg of lumps in the reactor with deposit formation on the helical stirrer. The amount of polymer powder bed in the reactor after shutdown was 217 kg.

Evaluation of the trend lines of pressure and temperature and the reproduction of the measurement signals of the radioactive absorption measurement indicated that protracted deviations of about 1-2% from the mean occurred within one hour in the trend lines of pressure and temperature. The reproduction of the measurement signals of the radioactive absorption measurement displayed irregular oscillating fluctuations in the second range, whose maxima and minima deviated by more than 50% from the mean of an idealized sawtooth curve both in respect of the intensity and in respect of the time axis.

The individual process parameters and the properties of the propylene-ethylene copolymer obtained are reproduced in Table I below.

The properties of the polymers obtained shown in Table I were determined as follows:

| | |
|---|---|
| Melt flow rate (MFR): | in accordance with ISO 1133, at 230° C. |
| | and 2.16 kg |
| Ethylene contents | by evaluation of corresponding IR |
| [% by weight]: | spectra |
| Productivity: | from the chlorine content of the |
| [g of polymer/g of | polymer obtained, which is in turn |
| catalyst] | determined by elemental analysis. The |
| | productivity was determined from the |
| | quotient of the chlorine content of |
| | the catalyst and the chlorine content |
| | of the polymer obtained. |
| Polymer powder morphology | by sieve analysis |
| [% by weight]: | |

Polymer powder morphology [% by weight]: by sieve analysis

TABLE I

| | Example 1 | Comparative Example A | Example 2 | Comparative Example B |
|---|---|---|---|---|
| Reactor pressure [bar] | 32 | 32 | 23 | 23 |
| Reactor temperature [5 C.] | 80 | 80 | 80 | 80 |
| Stirrer speed [rpm] | 80 | 80 | 80 | 80 |
| Hydrogen [% by volume] | 2.9 | 2.9 | 0.2 | 0.2 |
| Ethylene [% by volume] | | | 1.0 | 1.0 |
| MFR [g/min] | 43.4 | 44.2 | 2.1 | 2.0 |
| Ethylene content [% by weight] | | | 2.9 | 2.9 |
| Productivity [g of PP/g of cat] | 13,500 | 12,950 | 15,500 | 15,000 |
| Polymer powder morphology: | | | | |
| <0.125 mm [% by weight] | | | 2.4 | 2.9 |
| <0.25 mm [% by weight] | | | 6.7 | 6.1 |
| <0.5 mm [% by weight] | | | 13.8 | 15.3 |
| <1.0 mm [% by weight] | | | 31.2 | 30.4 |
| <2.0 mm [% by weight] | | | 41.3 | 35.1 |
| >2.0 mm [% by weight] | | | 4.7 | 10.2 |
| >5.0 mm [in g/20 kg of polymer | | | 50.6 | 480 |
| obtained] | | | | |

From the measurement results obtained, it can be seen that the radioactive backscattering measurement has, inter alia, the following advantages over the radioactive absorption measurement: a discrete sawtooth structure of the measurement signal for the fill level measurement, also equidistant discharge intervals, rapid and sensitive reaction to changes in the fill level, improved constancy of temperature, pressure and gas circulation, increased process stability associated with optimized morphology of the polymer powder obtained. Furthermore, less tendency for lumps to be formed in the reactor and an increase in productivity are observed. It is also helpful that the radioactive backscattering measurement as absolute measurement of the fill level of the reactor makes it possible to eliminate the dependence of the radioactive absolute measurement for monitoring of level on, inter alia, the vortex shape, the operating parameters and on the product type with the aid of the backscattering probe. The radioactive absorption measurement can be carried out using radiation sources of lower activity, which has the consequence that the radiation field around the reactor becomes lower and that the radiation sources used are easier to handle.

We claim:

1. A method of measuring the fill level of a reactor in continuously operated polymerization processes, where the respective phase interface in the reactor is measured by means of ionizing radiation, wherein at least one measuring unit comprising a radiation source which emits ionizing radiation and a corresponding detector is brought to the phase interface in the reactor and flexibly installed there, with the fill level of the reactor being measured by determining the phase interface by means of the radioactive backscattering measurement.

2. A method as claimed in claim 1, wherein the measuring unit comprising the radiation source and the detector is brought to the phase interface in the reactor and flexibly installed there.

3. A method as claimed in claim 1, wherein a plurality of measuring units each comprising a radiation source and a detector are positioned at different points in the reactor but in the vicinity of the phase interface for measuring the fill level of the reactor, with the measurement being carried out using that measuring unit which is closest to the phase interface.

4. A method as claimed in any of claims 1 to 3, wherein a radiation source which emits radioactive radiation is used.

5. A method as claimed in any of claims 1 to 4, wherein a scintillation counter is used as detector.

6. A method as claimed in any of claims 1 to 5 used in the continuous polymerization of C₂-C₈-alk-1-enes.

7. A method as claimed in any of claims 1 to 6 used in gas-phase polymerization processes.

8. A method as claimed in any of claims 1 to 7 used in polymerization processes carried out by means of a Ziegler-Natta catalyst system comprising a titanium-containing solid component a) together with cocatalysts in the form of organic aluminum compounds b), and electron donor compounds c).

9. A method as claimed in any of claims 1 to 8 used in polymerization processes carried out by means of a Ziegler-Natta catalyst system based on metallocene compounds or on polymerization-active metal complexes.

10. An apparatus for measuring the fill level of a reactor in continuously operated polymerization processes by measuring the respective phase interface in the reactor by means of ionizing radiation, where the respective reactor has at least one measuring unit comprising a radiation source which emits ionizing radiation and a corresponding detector and the measuring unit is flexibly installed at the phase interface in the reactor and the reactor fill level is measured by means of the radioactive backscattering measurement.

11. An apparatus as claimed in claim 10, wherein the measuring unit comprising the radiation source and the detector is mounted on a moveable rod which is installed at the phase interface in the reactor.

12. An apparatus as claimed in claim 10, wherein a plurality of measuring units each comprising a radiation source and a detector are installed at different points in the reactor but in the vicinity of the phase interface.
